(19) United States
(12) Patent Application Publication
(10) Pub. No.: US 2004/0103396 A1
(43) Pub. Date: May 27, 2004

(54) System for verification of enterprise software systems

(75) Inventor: Smadar Nehab, Tel Aviv (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Certagon Ltd.

(21) Appl. No.: 10/715,532

(22) Filed: Nov. 19, 2003

Related U.S. Application Data
(60) Provisional application No. 60/427,547, filed on Nov. 20, 2002.

(51) Int. Cl. G06F 9/44

(52) U.S. Cl. 717/127; 717/135; 717/114

(57) ABSTRACT

A system and a method for automatic verification of complex enterprise software systems, which improves the testing process by producing test scenarios using business process specifications.

This Application claims priority from U.S. Provisional Application No. 60/427,547, filed on 20 Nov. 2002, which is hereby incorporated by reference as if set forth in full herein.

### FIELD OF THE INVENTION

The present invention relates to a system and method for the automatic verification of complex enterprise software systems, by the use of process specifications to produce test parameters, and in particular, for such a system and method for analysis and verification of complex software systems for business process implementation and/or other processes which are easily described by state transition diagrams and which involve a plurality of actions that are capable of being performed manually.

### BACKGROUND OF THE INVENTION

Software for business process implementation is an important type of software system, which is used for at least partially automating many tasks involved in the functions of a business or other organization. Such automation increases the efficiency of operation of the business, by reducing the potential for human error and also by reducing the number of human operators required for performing menial clerical tasks. However, the effectiveness of such software systems depends upon the accuracy and reliability of operation of the software in comparison to the expectations of the functions of the business process.

There is a major gap between the key users who define the business process and developers who are doing the implementation of the system. As a result, it commonly happens that upon system launch, critical processes do not work and therefore extremely precious corporate resources are wasted. The implementation stage, which is the most costly period of the project, often takes more than twice as long as planned and becomes months rather than weeks.

As shown with regard to background art FIG. 1, the procedure for testing a software system starts with the development of a Software Test Plan (STP) that defines the requirements for the tests and refers to the processes that the system implements. The second stage of the process is writing up one or more Software Test Descriptions, which describe the way that the STP will be implemented. In this stage, each requirement/process defined by the STP is translated to a set of one or more STD's and each business process implemented by the software is translated to one or more STD's.

The third stage is the scripting of the various steps in each STD by means of an appropriate Record/Replay or scripting/macro system.

Finally, the test scripts are executed, generating Software Test Reports (STR) which are available for analysis.

It should be noted that most steps of the testing procedure described above are manual, with the exception of the replay of STD's and the generation of STR's. This manual testing is time consuming and therefore expensive. It must also be carried out by test specialists who are not normally experts in the field which the software system is intended to serve, which means that such experts are normally far removed from the review of test plans and results.

Significant progress has been made in the area of software testing in recent years, as more and more emphasis is given to testing methodologies. First templates and testing spreadsheets were introduced, and then configuration management and bug tracking databases. Presently the methodologies are similar, typically comprising the following steps: 1) start from test plan, 2) use an integrated database or configuration management tool (such as Rational RequisitePro, and Mercury TestDirector) to cover all stages of development from test plan, test description, test scenarios, bugs and code fixes. Automation is used for regression testing. Once the exact test scenarios have been exercised, they can be rerun. Typically, these systems are used for regression testing, such that the translation from test plan to test scripting is done manually and is managed using an integral database.

Currently available processes for testing software systems, such as are suggested in the background art, generally require a large amount of manual labor to translate enterprise processes (described by flow charts, or state transition diagrams) to a representative and exhaustive test plan. This manual labor is extremely time-consuming. As a result, the design of the tests may be less than optimal: there is a major time gap between a change of requirements and the change of the related tests. Moreover, registering the actual test descriptions with reference to the requirements is simply a “mission impossible”.

In order to increase efficiency of software testing in general, a number of different solutions have been proposed. Certain of these solutions rely upon software modeling to assist in software testing. However, none of these solutions are able to completely automatically generate tests from the description of the expected system behavior, rather these solutions require a detailed description of the software itself.

One example of an attempt at software testing through software modeling is found in a paper entitled “Using a model-based test generator to test for standard conformance” (see http://researchweb.watson.ibm.com/journal/sj/411/farchi.html). This paper describes attempts at determining software conformance, or the extent to which software behaves as described in specification of the software, by using a model-based test generator. The models are derived from finite state machine models. This approach is characterized in that it assumes that the software is written in a natural language, and also in that it attempts to measure the ability of the software to operate according to a determined specification. It does not however attempt to compare software behavior according to any other standard or description that is external to the software specification, because the model used for testing is developed from the software itself.

Another project for software testing, which represents a concrete implementation of a testing system described in the above paper, is called “GOTCHA-TCBeans” (see http://www.haifa.il.ibm.com/projects/verification/gtcb/index.html for a description). This testing system provides tools for reusing testing components, and for assisting users in creating tests once the state machine model has been determined. However, again the process starts with a description of the software specification, and does not rely upon an external model of the expected behavior of a process that is to be automated and/or otherwise supported by the software.

Still another potential system is described at http://www.research.ibm.com/softeng/TESTING/ucbt.htm, and describes use case based testing (UCBT), for assisting users in generating tests. However, as for the above systems, this system relies upon analyzing the software itself to determine appropriate tests, rather than analyzing the behavior of a process that is to be automated and/or otherwise supported by the software.

Similarly, other references describe auxiliary tools for helping users to perform various functions of test generation, but without using a model of the behavior of the process to be operated by the software. Instead, focus is maintained on analyzing the software itself and/or test processes for the software, rather than focusing on the process to be automated or operated by the software. For example, U.S. Pat. No. 6,546,506 describes a system and method for estimating time required for testing. In this patent, “test planning” involves planning how much time and effort will be required for manually planning, generating and executing the tests, but cannot solve the problem of test generation itself.

U.S. Pat. No. 6,349,393 describes the directed generation of tests for object-oriented software, in order to reach certain testing goals. Again, the system is able to assist with test generation, but relies upon a model which must be generated by the user.

Similarly, U.S. Pat. No. 6,353,897 also describes a test generation system which helps users to generate tests for object oriented software by providing extendible classes, but is not able to automatically construct a model according to which the tests may be generated.

Therefore all of these solutions focus on analyzing the software itself for testing, rather than examining the behavior of the process to be automated, supported or operated by the software.

### SUMMARY OF THE INVENTION

The background art does not teach or suggest a method and a system specifically for testing software for business process implementation. The background art also does not teach or suggest a system and method for automatically constructing a model of software behavior according to the business process specification. The background art also does not teach or suggest modeling of the business process itself for the purpose of test generation.

The present invention overcomes these deficiencies of the background art by providing a method and a system for testing software systems which implement business processes. The present invention analyses business processes, general requirements and rules, which optimally cover the process, within a specific implementation to generate abstract tests. These abstract tests examine the behavior of the software system as an implementation of the business process. The abstract tests are then used under a specific deployment and concrete constraints to generate detailed test descriptions and scripts. Therefore, the business process model is analyzed, rather than the structure of the software itself. With regard to the software, the expected behavior (or output from a given input) is determined according to the model of the business process.

Preferably, the present invention automatically produces test scenarios and/or an abstract test description from the analyzed business process specification. Next, the test scenarios (or abstract test description) are preferably used to automatically generate test scripts, which are then more preferably executed. Optionally and most preferably, the results of the test script execution are analyzed in order to assess the performance of the software, and in particular, to assess the conformance of the software with the requirements of the software specification. The software systems are preferably those used for the management and control of business applications, non-limiting examples of which are: billing, Enterprise Resource Planning (ERP), Customer Requirements Management (CRM), Supply Chain Management (SCM), Human Resource management. A business application may optionally automate management and control of corporate or other organizational activities.

As mentioned the present invention is optionally and most preferably able to automatically test and analyze the compliance of the software system implementation with the business process specification.

It should be noted that “business process” may optionally refer to any process which is easily described by state transition diagrams and which preferably involves a plurality of actions that are capable of being performed manually. The term “business process” may also optionally refer to an automation of one or more manually performed business processes, for example through the provision of Web services. The term “business process” may also optionally include any type of process that may be included within a business application as previously defined. The term “business” may optionally include any type of organization or group of human beings, including but not limited to, a hospital, a company, a school or university, a for-profit institution and a non-profit institution.

According to a preferred embodiment of the present invention, the business process specification is provided in a modeling language, such as UML activity diagrams for example. These standard languages enable the business process to be described as a plurality of states with transitions, which is useful for determining expected results for particular actions and also for test generation, as described in greater detail below. Other non-limiting examples of such standard languages include business process descriptions or specifications in a preferred formal language. Examples of such formal languages include but are not limited to, UML (unified modeling language) activity diagrams, UML sequence diagrams or UML state charts, BPEL (business process execution language) standard language, BPML (business process modeling language) standard language, any type of BML (business modeling language) or any other equivalent language.

A general reference to the utility of UML as an example for model construction for test generation is “Using UML for Automatic Test Generation” by Charles Crichton, Alessandra Cavarra, and Jim Davies (http://www.agedis.de/documents/d133_{—}1/ASE2001.pdf as of Nov. 10 2003, published Aug. 10 2001). This reference does not provide any guidance for the specific example of generating tests for software for business processes, and indeed only provides a bare outline of a method for using UML for test generation. Thus, only the present invention is able to overcome the disadvantages of the background art for automated test generation for software for implementing business processes.

For the present invention, a software application could be written in substantially any suitable programming language, which could easily be selected by one of ordinary skill in the art. The programming language chosen should be compatible with the computational device according to which the software application is executed. Examples of suitable programming languages include, but are not limited to, C, C++ and Java.

In addition, the present invention could be implemented as software, firmware or hardware, or as a combination thereof. For any of these implementations, the functions performed by the method could be described as a plurality of instructions performed by a data processor.

### BRIEF DESCRIPTION OF THE DRAWINGS

The invention is herein described, by way of example only, with reference to the accompanying drawings, wherein:

FIG. 1 is a schematic flow diagram of an exemplary procedure for testing software according to the background art;

FIG. 2 is a schematic block diagram of an exemplary system according to the present invention;

FIG. 3 is a schematic block diagram of an alternative exemplary system according to the present invention;

FIG. 4 shows a flow chart of an exemplary method according to the present invention;

FIG. 5 is a schematic block diagram of an exemplary system according to the present invention;

FIG. 6 is a schematic block diagram of an exemplary test planner from FIG. 5 according to the present invention;

FIG. 7 is a schematic block diagram of an exemplary test generator from FIG. 5 according to the present invention; and

FIG. 8 is a schematic block diagram of an exemplary simulator from FIG. 5 according to the present invention.

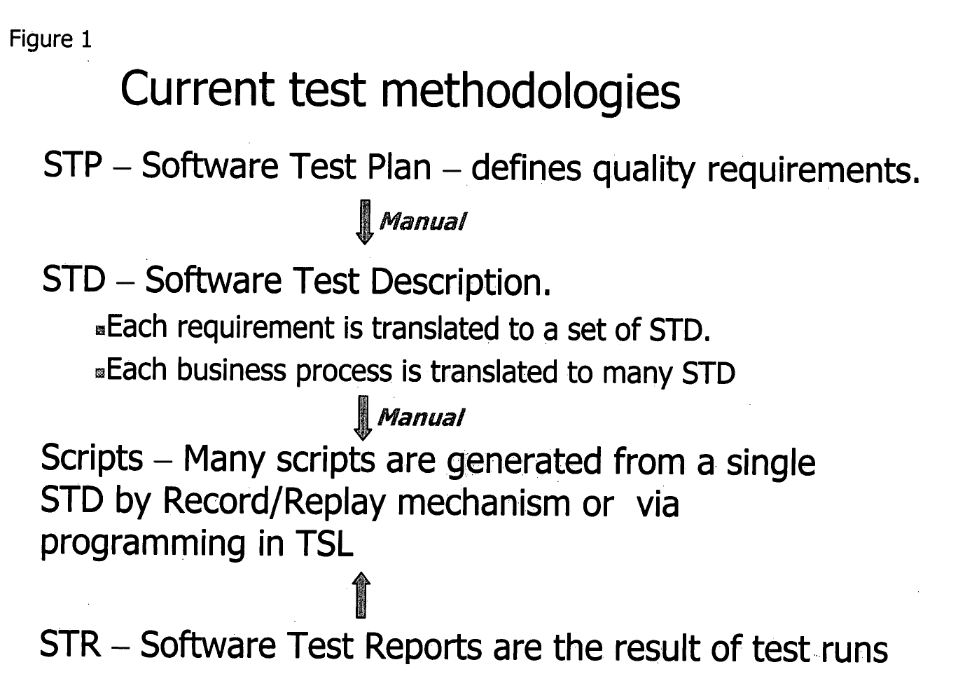

### DETAILED DESCRIPTION OF THE INVENTION

The present invention provides a method and a system for testing enterprise business software systems through automatic test generation.

The present invention analyses business processes, general requirements and rules, which optimally cover the process, within a specific implementation to generate abstract tests. These abstract tests examine the behavior of the software system as an implementation of the business process. The abstract tests are then used under a specific deployments and concrete constraints to generated detailed test descriptions and scripts.

Preferably, the present invention automatically produces test scenarios and/or an abstract test description from the analyzed business process specification. Next, the test scenarios (or abstract test description) are preferably used to automatically generate test scripts, which are then more preferably executed. Optionally and most preferably, the results of the test script execution are analyzed in order to assess the performance of the software, and in particular, to assess the conformance of the software with the requirements of the software specification. The software systems are preferably those used for the management and control of business processes, non-limiting examples of which are: billing, marketing and distribution, and personnel management. Thus, the present invention is optionally and most preferably able to automatically test and analyze the compliance of the implementation to the business process.

According to a preferred embodiment of the present invention, the system for automatic testing of such software for business process implementation preferably receives, as input, business process descriptions or specifications in a preferred formal language. Examples of such formal languages include but are not limited to, UML (unified modeling language) activity diagrams, UML sequence diagrams or UML state charts, BPEL (business process execution language) standard language, BPML (business process modeling language) standard language, or any other equivalent language.

The business process specification is preferably written in some type of BML (business modeling language), and more preferably is written in BPML, which is a language for specifying and describing business processes that is well known in the art (see for example the description provided by BPMI.org: http://www.bpmi.org as of Aug. 1, 2001). BPML describes different activities, which comprise a business process, supports specification of the participants in the business process, and also supports the use of rules to specify the expected behavior of the business process under different conditions. BPML further enables the specification to be written in an XML (extended mark-up language) format, as a version of HTML (hypertext mark-up language).

The use of any of these standard languages preferably enables the business process to be modeled as a plurality of states and transitions. Entities such as customers, etc may be defined by using class diagrams. Optionally, a stereotype may be used as a constraint on the behavior of the entities with regard to the model. For example, a grace period for payment may optionally be different for business as opposed to residential customers; such a difference is preferably specified as part of the business process specification, and is a non-example of a type of business rule. An activity diagram defines the business process itself. Language extensions, such as UML extensions for example, may optionally be used to define other properties.

Within this description of the model, states and transitions may optionally be assigned properties, such as priorities for example. These priorities are preferably used for test generation, in order to be more certain that particular aspects of the software under test (or system under test, as described below) are examined. Priorities may also optionally be determined according to the value for a stereotype. The value assigned to an entity in a particular state preferably depends upon the stereotype.

The system then preferably analyzes each of the transitions of the business process. A transition preferably includes a starting state, a target state, and a condition or event that causes the change from the starting state to the target state. Each such transition provides the basis for a test primitive of the system.

Each test primitive may optionally be used to determine a plurality of actual tests, more preferably by determining an abstract test from which the actual test may optionally be generated. As described in greater detail below, the abstract test is preferably represented as a test tree. A directed random generation engine is then preferably used to select the specific optimal tests that can be chosen to test the requirements for the business process. The directed random generator preferably ensures that all inputs comply with these requirements and that, if desired, data and tests are optionally generated according to a priority. The priority may optionally be determined as previously described.

The generated tests are optionally compared to the set of all possible tests, preferably to consider issues of functional coverage.

The resulting tests are then optionally translated using a connector hub technology into concrete calls to the tested system. The system under test is then run on the generated inputs, simulating the required events and measuring the actual results as compared to the expected results.

The system of the present invention preferably features at least a generator for generating tests from the business process specification, which more preferably features a plurality of rules. The system also preferably features a modeling module for using the rules, and applying them to data provided from the generator and/or from the software system being tested. The modeling module more preferably uses these rules by modeling the behavior of the specified processes and generating output representing predicted results, which may be compared with the actual results output by the software system. Optionally and more preferably, the system of the present invention further features a data entry system for entering business process specifications; a rules file for storing rules derived from business processes; and a validation module for comparing the system results against the model results.

According to preferred embodiments of the present invention, the system and method are preferably able to receive a specification of a business process according to which a software system is to be operated, and to automatically generate relevant end-to-end usage test scenarios. It should be noted that although the behavior of the software system is tested, the behavior (and hence the generated tests) rely upon the specified business process, which as noted above also includes one or more actions performed by a human individual. Therefore, the tests must incorporate both aspects of the system to be tested.

According to preferred embodiments of the present invention, the system more preferably features a core engine, which generates a set of tests that are as complete as possible, and more preferably prioritizes them. Such prioritization may also optionally be used to reduce the number of tests that are performed. The system more preferably supports continuous monitoring of the business process testing coverage, and most preferably enables coverage priorities to be assigned to various aspects of the business process.

One or more abstract tests and any test instructions created during the process of analyzing the business process specification are passed on to a generator application which generates test documents, test data, and scripts, and which can preferably connect to any pre-defined enterprise system adaptors or connectors (see below for a description of a connector hub, which also acts as an interface to the software system under test).

According to an optional embodiment of the present invention, there is provided a method for verification of a software system for performing a business process. The method preferably includes modeling the business process to form a model. The model is then preferably analyzed according to a plurality of actions occurring in the model. Such actions may optionally be transitions for a transition state diagram, as described in greater detail below.

Next, at least one test strategy is developed according to the plurality of actions. For example, a test strategy preferably features at least one test which includes the actions, for testing the software system. Next, at least one test is preferably generated according to this at least one test strategy.

Optionally, developing this at least one test strategy also includes determining a priority with respect to the test (an optional method for determining priority is described in greater detail below); and controlling and optimizing for corner cases and risk points. This latter process is well known in the art of verification for chip design and other types of verification processes; it is optionally performed to be certain that extreme or unusual situations are examined during the testing process.

The test generation process also preferably includes controlling test runs; and deriving or obtaining an analysis, comparison and coverage of test results from the test runs. Test generation also preferably includes generating scripts; and connecting to a connector for operating the test on the software system.

The present invention has a number of advantages, including being able to operate within the existing and standardized implementation process, while providing improved quality when the software system is first implemented. The present invention also supports increased automation of the implementation management. Furthermore, the automation of the test generation provided by the present invention also eliminates a significant portion of the testing effort and makes such tests more efficient to create and run.

The principles and operation of a system and a method according to the present invention may be better understood with reference to the drawings and the accompanying description, it being understood that these drawings are given for illustrative purposes only and are not meant to be limiting. Furthermore, although the following discussion centers around a billing and customer care (BCC) system it is understood that the description would be applicable to any complex software system. Also, although the following discussion centers around business process specification written in BPML as a preferred embodiment of the present invention, it is understood that the description would be applicable to any language or protocol which may be used to describe and model process specifications.

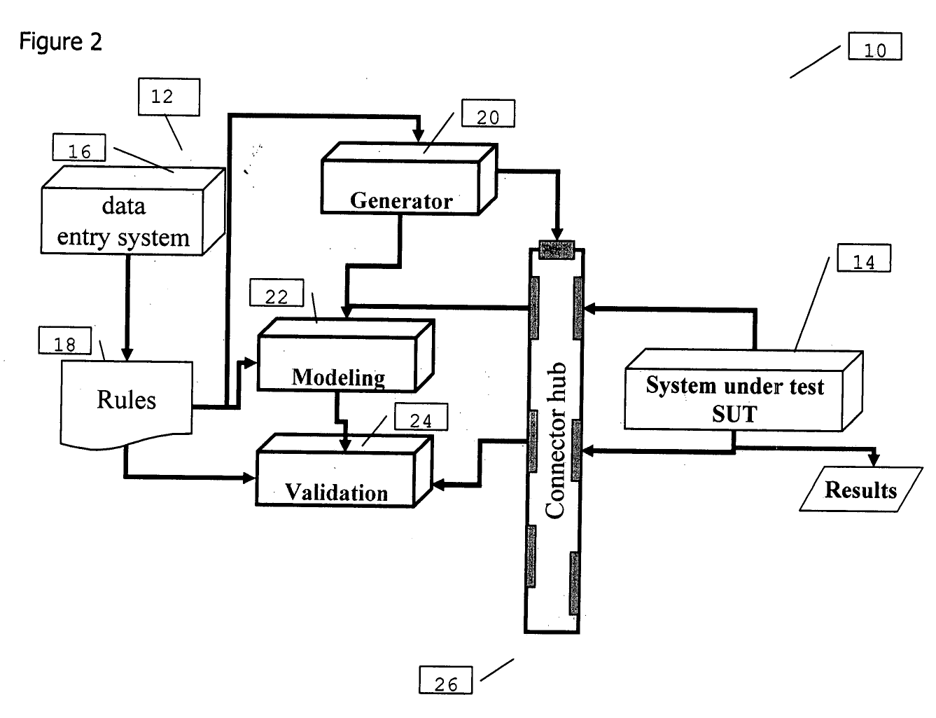

Referring now to the drawings, FIG. 2 is a schematic block diagram of an exemplary (optional but preferred) implementation of a system according to the present invention, shown as system 10 for the purposes of illustration only without any intention of being limiting.

System 10 includes a verification system 12 and a Software Under Test (SUT) 14, which may also optionally be referred to as software under test (for the purposes of the present invention, these two designations are interchangeable). SUT 14 includes at least one software system, and optionally a plurality of software systems, which are preferably software for business process implementation and which are to be tested.

Verification system 12 features a data entry system 16, which is used to enter the business process specification in a graphical or textual mode.

One or more business process descriptions from the business process specification are entered into data entry system 16 and are stored in a rules file 18. A generator 20 generates test descriptions from the business process descriptions stored in rules file 18. Preferably, generator 20 features a constraint solving system that preferably ensures that all generated scenarios and objects obey the requirements of the predefined business processes. These tests are then used to test SUT 14.

Optionally and preferably, generator 20 can run iteratively to ensure the coverage of specific test scenarios. Optionally and more preferably, generator 20 can cover extreme case scenarios or other scenarios of interest. Optionally and still more preferably, generator 20 can create new scenarios on the fly.

For this optional but preferred implementation of the present invention, modeling module 22 uses the rules and applies them to the data as fed either from generator 20 or from SUT 14. Modeling module 22 models predicted behavior and outputs the predicted or desired results of executing the tests for comparison with the results of actually executing the tests with SUT 14.

A validation module 24 compares the actual results against the predicted results. Validation module 24 also refers to the rules stored in rules file 18. According to a preferred embodiment of the present invention, these rules describe a model of the business process as a plurality of states and transitions. However, alternatively and more preferably, modeling module 22 is able to execute the state machine in order to determine the expected results. In this implementation, validation module 24 preferably compares expected test results to actual test results.

Verification system 12 and SUT 14 are optionally and preferably connected by connector hub 26, which enables the generated tests to be executed by the actual components of SUT 14. Optionally and preferably, these generated tests are mapped to the expected inputs to SUT 14. A mapping may be as simple as translating one data structure and defining an SQL statement (or other database protocol statement) to access this data structure, and it can be very complex, for example by mapping to a few objects with an online protocol. For example, connector hub 26 may optionally be required to provide a plurality of inputs to SUT 14 in order to be able to execute the test, optionally, one or more inputs may be required even before test execution is started, in order for SUT 14 to be able to receive the input(s) required for the test itself. The mapping is also optionally and preferably used for the situation in which SUT 14 features a plurality of systems, and the test requires interaction and/or passing of interim results between these different systems. Such a mapping may also optionally be used when SUT 14 is required to communicate with a system that is not under test.

According to preferred implementations of the current invention, connector hub 26 optionally and preferably enables verification system 12 to be easily implemented and operated separately from SUT 14. According to further optional and more preferred implementations of the current invention, any one implementation of verification system 12 may be easily reconfigured for use with other examples of SUT 14, such that connector hub 26 preferably acts as an interface between verification system 12 and SUT 14.

According to a particularly preferred embodiment of the present invention, SUT 14 is not an existing system but instead comprises a virtual SUT. More preferably, when actual integration is needed, connector hub 26 may then be changed to connect verification system 12 to an external SUT 14. This enables creation of an implementation of test system 12 prior to implementation of SUT 14.

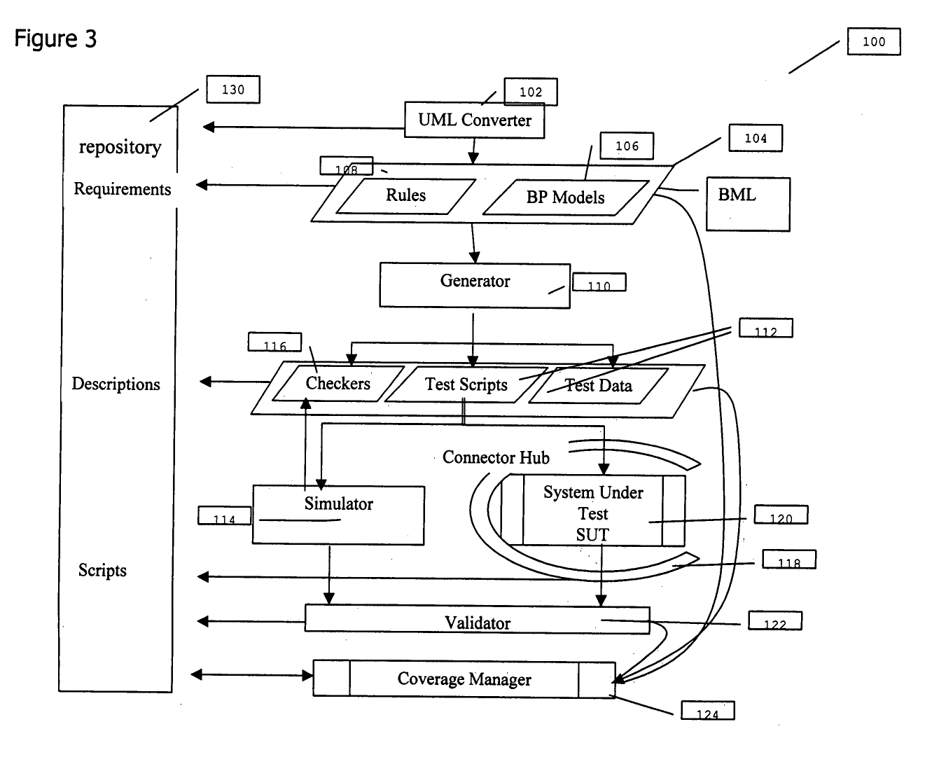

FIG. 3 shows an alternative exemplary implementation of a system according to the present invention shown as system 100 for illustrative purposes only. As shown, system 100 includes a specification in UML that is converted to a proprietary modeling language, shown as BML 104, by a UML converter 102. As previously described, BML 104 may optionally be performed with any business process modeling language. The business processes, described in BML 104, preferably comprise a business process model (BP) 106 and a plurality of rules 108.

BML 104 is preferably analyzed by a generator 110. Generator 110 generates sample data and actions for the test scenarios, shown as a plurality of tests 112. The data and scripts from tests 112 are preferably first fed into a simulator 114, which calculates expected results and feeds it back to generate a complete test. Now the generated tests include sample data, actions and expected results. Optionally, these generated tests are checked by a checker 116, for example to verify that these tests comply with the business rules, such as rules 108.

As such the generated tests can optionally and preferably be run through a connector hub 118 in order to be converted to real system data. The data and actions are translated to system data and the actions typically to workflow events. Connector hub 118 then preferably feeds these tests to a system under test (SUT) 120, which is the software system for performing the business process that is being tested. Alternatively, SUT 120 may optionally receive this information directly as tests 112.

In any case, when SUT 120 produces results for the data and actions, this data is preferably received by connector hub 118 and then compared to the results as calculated by checker 114. Optionally and preferably, this process is performed, and the test success is defined, by a validator 122. The requirements in the form of BML 104, the physical tests as represented in 112 as well as results from validator 122 are all fed into a coverage query and reporting system 124.

In all stages intermediate data and results are preferably saved to a repository 130, which also interfaces with external test and configuration management systems, such as Rational Requisite Pro for Requirements Management Systems (RMS), Mercury Test Director for a Test Management System (TMS) and Rational ClearCase as a Configuration Management System (CMS) to keep track of all test stages.

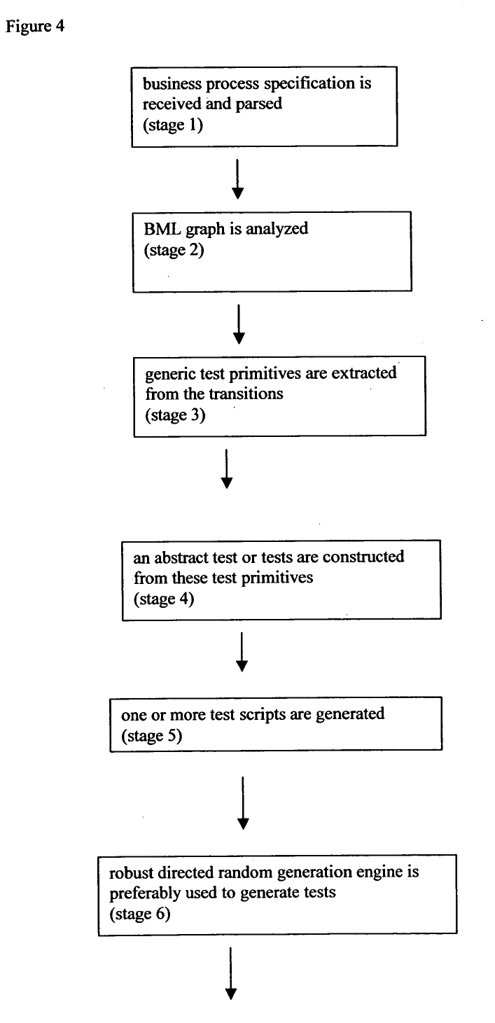

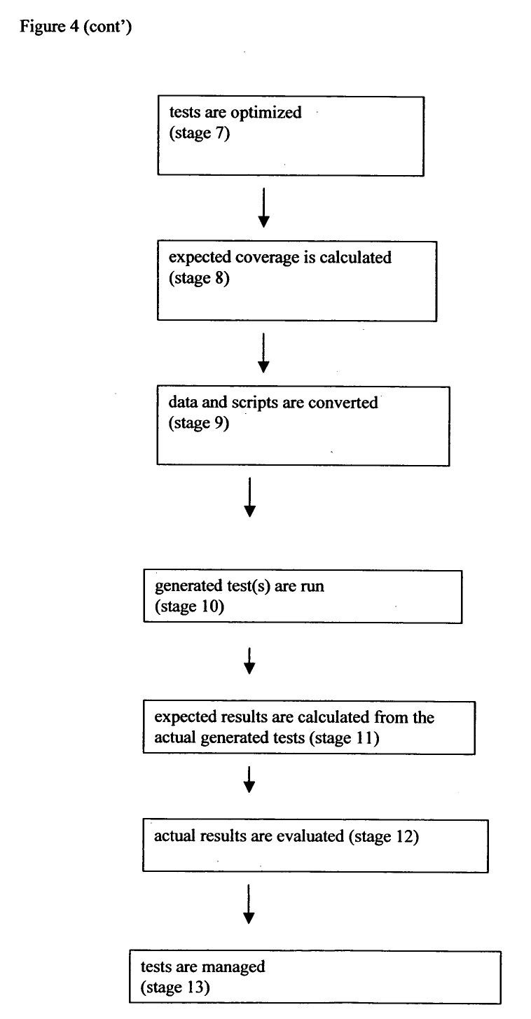

FIG. 4 shows a flowchart of an exemplary method according to the present invention. As shown, in stage 1, the business process specification is received, preferably written in BPML, which is then parsed. Optionally, the specification may be written in any suitable modeling language such as UML for example, and then optionally converted to a BML graph. In stage 2, the BML graph is analyzed to determine states and transitions, and optionally also priorities. Graph analysis algorithms which are known in the art may optionally be used to calculate paths using priorities and other input attributes. Next, priorities are set. Alternatively, analysis may optionally be performed in another manner, without using a graph, but preferably enabling the states and transitions to be determined.

In stage 3, generic test primitives are extracted from the transitions. These primitives should preferably include <data, action, expected result>. Data and actions are examples of “constrained random variables”, in that they may optionally be filled with values during test generation and execution that are determined according to directed random generation. The action optionally and preferably includes temporal constraints. The expected result is defined as a dependent random variable. Priorities are preferably preserved during this process.

In stage 4, an abstract test or tests are constructed from these test primitives. The abstract test may optionally be in the form of a test tree, in which each node is preferably a test primitive, such that the nodes preferably represent and/or are at least related to the transitions of the previously described transition state diagram. Edges between the nodes represent ordering of transitions. Optionally a tree is generated for each business process or subprocess, in order to provide a compact representation of at least a plurality of possible test structures. Each path on the tree, from the root to the leaf, preferably represents a single test structure. As described in greater detail below, each test structure may optionally be used to generate a plurality of different random or directed random tests.

Optionally and more preferably, a priority is calculated for each abstract test or test structure, most preferably as an aggregated priority which includes priorities for reaching particular state(s) and also priorities for particular transition(s). Each tree also optionally and more preferably receives a calculated priority.

Next in stage 5, preferably one or more test scripts are generated from the test tree and/or other abstract test. Each such test script represents a particular test structure as previously described. Optionally, during generation of the test script, a “look ahead” process is performed, which reviews potential future nodes before they are added to the script. For example, depending upon the values of particular nodes of the tree, different paths may be required to traverse the tree from its root to a leaf. Also, certain values may lead the business process to end, if for example a customer continues to refuse to a pay for an on-going service, such that the service is disconnected for that customer.

The tree may also optionally be “pruned” or adjusted for particular abstract tests; for example, those portions of a tree which are not relevant for tests involving a particular type of customer may optionally be removed, as the test cannot use those parts of the tree. This process enables tests to be generated more efficiently, as otherwise various constraints would need to be examined during generation of the actual test, such that particular tests or portions of tests might need to be discarded during generation.

In stage 6, a robust directed random generation engine is preferably used to generate tests by assign values to tests according to the test scripts.

In stage 7, the tests are preferably optimized. Synchronized test scripts are preferably generated by using derived priorities and test scheduling considerations. Existing third party engines (software) can optionally be used for the scheduling optimization, as algorithms and techniques for such optimization are well known in the art. In stage 8, expected coverage is preferably calculated.

In stage 9, the data and scripts are preferably converted to documents and optionally a connector format for enabling actual execution of the tests through a connector hub, as previously described. In stage 10, the generated test(s) are preferably run, optionally manually, but more preferably automatically. According to one embodiment of the present invention, there is provided one or more connector hubs to a software package which can automatically perform the tests with the software system under test.

In stage 11, the expected results are calculated from the actual generated tests and the model of the business process.

In stage 12, the actual results are evaluated. Preferably test runs are performed, and the expected results are then compared to the actual results from the test runs, or alternatively from the complete set of all tests. The actual coverage achieved is preferably then calculated. In stage 13, the tests are managed, optionally and preferably in order to execute all tests in the set, more preferably with at least one adjustment made to these tests in order to provide increased coverage.

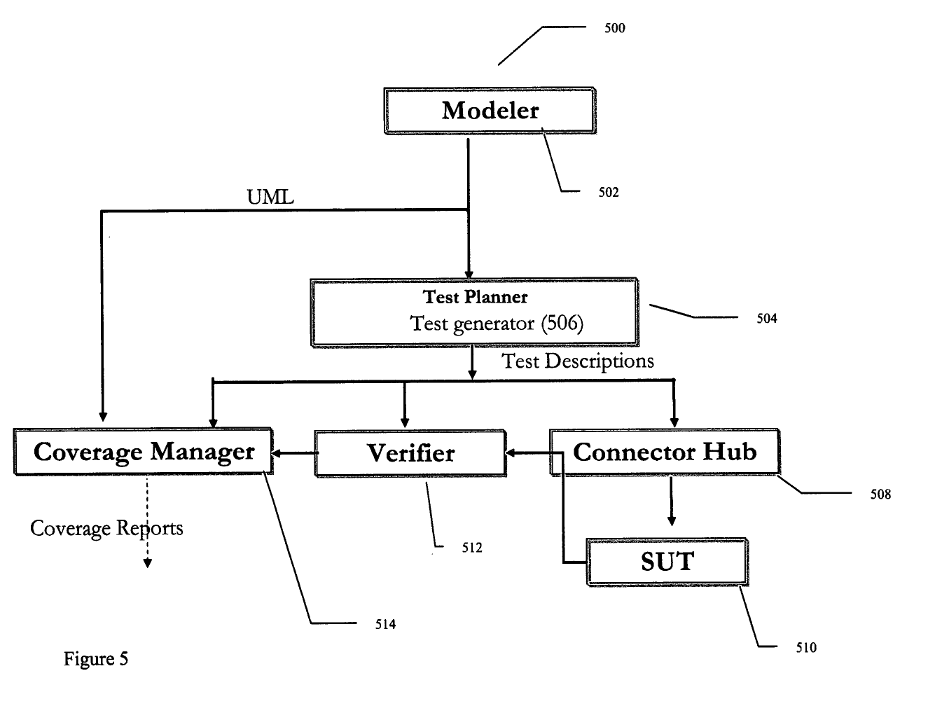

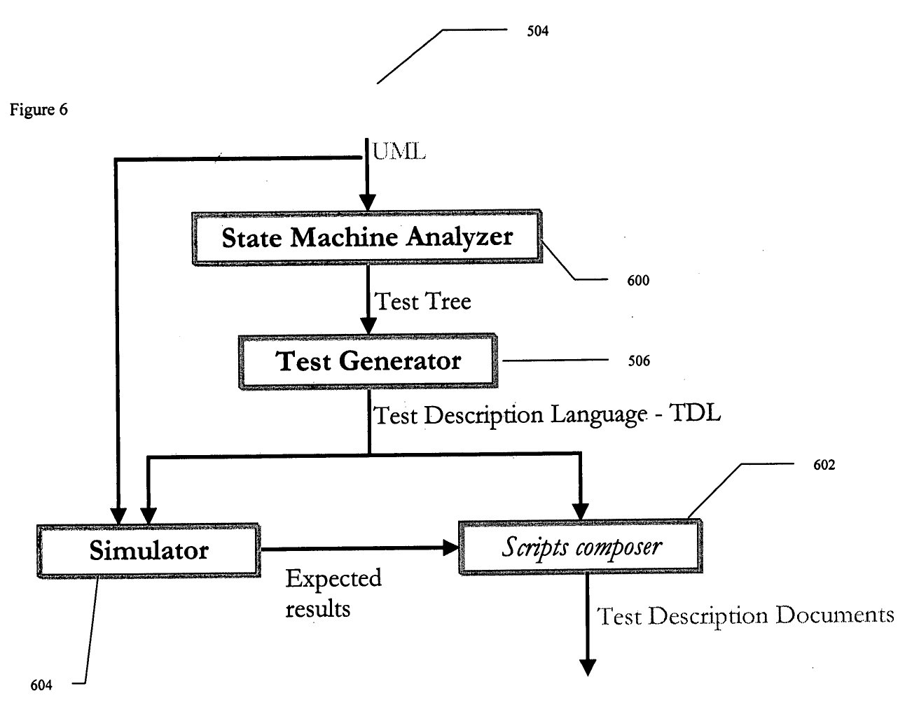

FIGS. 5-8 show another exemplary preferred embodiment of the system of the present invention. FIG. 5 provides an overview of an exemplary system 500 according to the present invention; FIGS. 6, 7 and 8 each show the test planner, test generator and simulator, respectively, in greater detail.

FIG. 5 is a schematic block diagram of system 500 according to the present invention. As shown, system 500 preferably features a modeler 502 for receiving the business process specification, and optionally also one or more testing priorities. Modeler 502 then preferably analyzes the business process specification, in order to determine the expected behavior of the business process. Model 502 optionally interacts with the user to determine the testing priorities and/or the business model.

This information is then preferably passed to a test planner 504. Test planner 504 optionally and more preferably determines the states and transitions between states for the business process model. Each such transition optionally and preferably represents a test primitive. Test planner 504 preferably determines one or more abstract tests from one or more test primitives, preferably determined from the transition(s). Test planner 504 then preferably connects to or at least communicates with a number of different components for performing various aspects related to test performance. For example, test planner 504 preferably communicates with a connector hub 508 as previously described, in order to actually implement the test with software under test (SUT) 510. Connector hub 508 preferably enables the directives or commands in the test to be translated to the language or protocol used by SUT 510.

Test planner 504 also preferably communicates with a verifier 512, for providing the expected results of the generated tests. Connector hub 508 also preferably communicates with verifier 512 in order to provide the actual test results. Verifier 512 preferably compares the expected test results with the actual test results, in order to verify correct function of SUT 510.

Verifier 512 then preferably communicates this information to a coverage manager 514. Coverage manager 514 then preferably at least determines the coverage provided by the tests, and optionally also determines one or more aspects of the behavior of SUT 510 which require the generation of further tests. This information is then preferably returned to test planner 504, for planning and generating further tests (not shown).

FIG. 6 shows test planner 504 in greater detail, with a test generator 506. As shown, test planner 504 preferably receives the business process specification in some type of modeling language, which features a plurality of states and transitions. These states and transitions are preferably analyzed by a state machine analyzer 600. State machine analyzer 600 preferably then generates a test tree as previously described. This tree (or other hierarchical description) is then used by test generator 506 to generate one or more abstract tests, preferably in a TDL (test description language).

These abstract tests are preferably passed to a script composer 602, which generates one or more scripts. These scripts are the actual tests, which are preferably passed to connector hub 508 (not shown) for actual implementation with SUT 510 (also not shown).

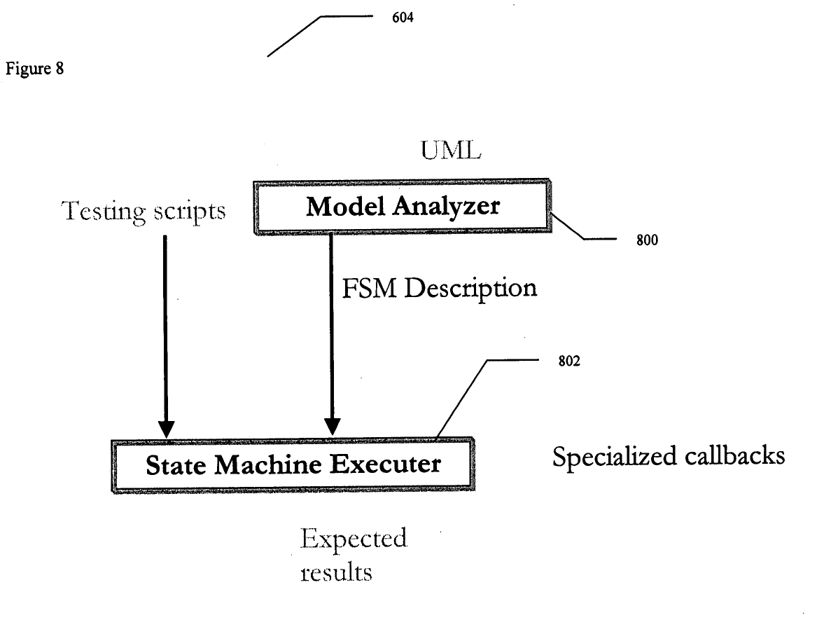

In addition, the abstract tests are preferably passed to a simulator 604 for simulating the performance of the tests to determine the expected test results according to the model of the business process specification (see FIG. 8 for more details). The expected test results are then passed to verifier 512 (not shown) as previously described, preferably through script composer 602.

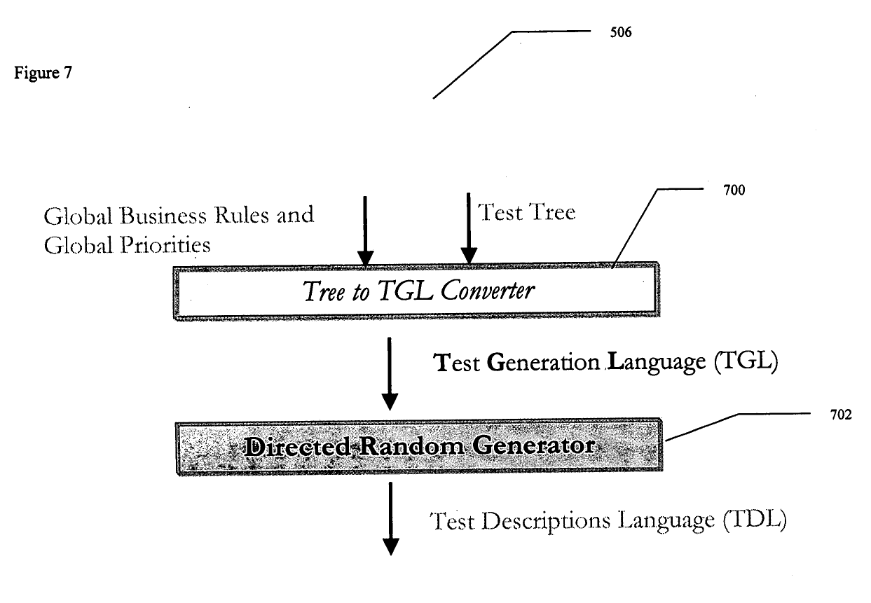

FIG. 7 shows test generator 506 in greater detail. As shown, test generator 506 preferably features a converter 700, for receiving the test tree (or other hierarchical description of the tests, from the abstract tests). Optionally and preferably, converter 700 also receives one or more business rules or priorities, which optionally may be used as constraints on the test generation process. As previously described, such constraints enable tests to be generated which operate according to possible or potential inputs and system behavior for the business process.

Converter 700 then preferably transforms the abstract tests into a test generation language (TGL). This process may optionally be performed by traversing the test tree, and converting each node into a TGL statement. Actions may optionally be translated into modifying attributes in the statements. These attributes in turn may optionally be assigned by using constraints to control and direct the test generation process, such that “forbidden” and/or non-logical values are not permitted. Values may be “forbidden” because of business rules, for example. TGL is based upon the Python language (see Programming Python (second edition) by Mark Lutz, O'Reilly publishers) which is a standard object oriented scripting language that is well known in the art.

Also optionally and preferably, TGL is used in order to support calls to external systems in order to verify the occurrence of particular events; for example if a letter is sent or some other action occurs.

A non-limiting, illustrative exemplary TGL test description may optionally be constructed as follows. This example concerns procedures to be followed when a customer fails to pay for an ongoing service, such as a telephone line for example.

C=Customer (

State=Init

Type=Business

Debt=“>min( )”

Statetime=( )) //the customer is a business, which has a debt greater than a minimum; it has just entered this state

Wait c. grace ( ) // This means that waiting or grace period is required

If c.state < > PostLetter or !eventSendLetter ( ) //after the waiting period, a letter needs to be sent to the customer about the failure to pay

. . . fail test . . . //failure to send the letter indicates that the software system has failed the test

Wait c.grace ( )

If c.state < > PostCsr or !eventMakeCsrCall( ) //after the waiting period, the customer needs to be called by a customer service representative about the failure to pay

. . . fail test . . .

c.debt=“> max ( )” //the debt is now greater than a maximum amount

if c.state < > Disconnected or !eventDisconnected( ) //if the customer is not disconnected then the software has failed the test

. . . fail test . . . .

Test descriptions in TGL are then preferably passed to a directed random generator 702, which as previously described preferably generates the actual tests. The tests may optionally be generated by using a “generate and test” approach, in which the test is generated, after which its compliance with the required constraint(s) is examined; only those tests which comply with the constraints are used. Backtracking may also optionally be used, in which the value of a previous variable is changed if a subsequent variable cannot be assigned a consistent or allowed value.

Turning back to the above TGL test description, the debt of the customer may optionally originally be assigned a value of 10 (which is greater than “min debt”), followed by assigning “c.debt” a value of 2000 (which is greater than “max debt”), at which point disconnection should occur, for generating an actual test to be executed.

Optionally and more preferably, the tests are generated in a test description language (TDL) as previously described.

FIG. 8 shows an exemplary implementation of simulator 604 in more detail. As shown, simulator 604 preferably features a model analyzer 800, for analyzing the model of the business process specification. Model analyzer 800 preferably then generates a finite state machine description of the business process specification, which is preferably passed to a state machine executer 802. State machine executer 802 also preferably receives the test scripts for the actual tests, and then preferably calculates the expected results according described by the state machine. Therefore, the expected behavior of the SUT is analyzed through the analysis and execution of the model for the business process, in order to determine the expected results of the executed tests. Thus, a model of the software itself is not required for the operation of the present invention.

State machine executer 802 may optionally be extended by call back functions, to simulate the system actions that cause a state transition. For example, to simulate a zip code failure test, a system module that calculates zip code compliance can be called directly from the simulator.

While the invention has been described with respect to a limited number of embodiments, it will be appreciated that many variations, modifications and other applications of the invention may be made.

What is claimed is:

1. A system for testing the implementation of a software system for performing a required business process comprising:
(a) a business process specification for specifying the business process in a BPML compliant language;
(b) an analysis module for generating a plurality of possible valid test scenarios;
(c) a directed random engine or a constraint solving system for randomly generating tests according to said test scenarios, such that said tests are limited according to at least one of a business priority and a testing priority; and
(d) a simulator for determining expected results for said generated tests.

2. The system of claim 1, wherein said simulator determines said expected results according to said business process specification

3. The system of claim 1, wherein the software system is determined according to a software specification, said software specification determining inputs for said generating said tests by said directed random engine or said constraint solving system, said inputs also being determined according to said business process specification.

4. The system of claim 1, further comprising:
a modeling module for receiving said rules from said business process specification and applying said results from executing said generated tests.

5. The system of claim 4, wherein said modeling module models behavior of the business process and generates output representing predicted results for said simulator.

6. The claim of claim 5, further comprising: a validation module for comparing said expected results to said results from executing said generated tests.

7. The system of claim 6, further comprising:
a coverage system for calculating coverage provided by said generated tests.

8. The system of claim 1, further comprising
connector hub technology for translating said plurality of tests into concrete calls to the software system.

9. The system of claim 7, wherein said analysis module analyzes each transition of the business process according to said business process specification.

10. The system of claim 9, wherein said transition comprises a starting state, a target state, and a condition or event that causes a change from said starting state to said target state.

11. The system of claim 10, wherein at least one test primitive is determined from at least one transition.

12. A method for testing the implementation of a software system for performing a required business process, comprising:
providing a specification for describing the business process;
analyzing said specification to form an analysis of the business process; and
generating at least one test for testing the software system for performing the business process according to said analysis.

13. The method of claim 12, wherein said specification comprises at least one general requirement for performing the business process and at least one rule for being fulfilled by the software system.

14. The method of claim 12, further comprising:
performing said at least one test to obtain a result; and
analyzing said result to determine a performance of the software system.

15. The method of claim 14, wherein analyzing said result further comprises determining coverage provided by said at least one test.

16. The method of claim 15, wherein said generating said at least one test further comprises:
performing an initial generation of at least one test;
performing said at least one test to obtain a result;
analyzing said result to determine coverage of said at least one test; and
generating a plurality of tests according to said coverage.

17. The method of claim 16, wherein said analyzing said result to determine said performance of the software system further comprises:
determining an expected result from the software system according to said specification; and
comparing said expected result with an actual result to determine said performance of the software system.

18. The method of claim 12, wherein said generating is performed at least partially according to a directed random generation engine.

19. The method of claim 12, wherein the software system implements a plurality of business processes as a business application.

20. The method of claim 19, wherein said business application is selected from the group consisting of billing, Enterprise Resource Planning (ERP), Customer Requirements Management (CRM), Supply Chain Management (SCM), Human Resource management.

21. A system for automatic verification of the implementation of a software system for performing a required business process, the business process being described according to a specification, the system comprising:
(a) a generator for automatically generating tests from at least one rule specified in the specification of the business process;
(b) a simulator for generating at least one expected result of said tests from the specification;
(c) a connector for receiving an actual result of said tests from the software system being tested; and
(d) a validator for comparing said actual result with said at least one expected result.

22. The system of claim 21 further comprising:
(e) a data entry system for entering said at least one specification of at least one process.

23. The system of claim 21, wherein said connecter receives said actual result of said tests from a simulation of said software system.

24. The system of claim 21, wherein said generator comprises a directed random generation engine.

25. A method for verification of a software system for performing a business process comprising:
modeling the business process to form a model;
analyzing the model according to a plurality of actions occurring in the model;
developing at least one test strategy according to said plurality of actions; and
generating at least one test according to said at least one test strategy.

26. The method of claim 25, wherein developing said at least one test strategy, further comprises:
determining priority with respect to said test;
controlling and optimizing for corner cases and risk points.

27. The method of claim 26 wherein generating said at least one test further comprises:
controlling test runs; and
determining an analysis, comparison and coverage of test results from said test runs.

28. The method of claim 26 wherein said generating further comprises:
generating scripts; and
connecting to a connector for operating the test on the software system.

29. A method for testing web services based implementation of a software system, the software system performing a process, comprising: providing a specification for describing the process and the Web services;
analyzing said specification to form an analysis of the process and the Web services; and
generating at least one test for testing the software system for performing the process according to said analysis.

30. The method of claim 29, wherein the Web services perform, integrate with or connect to, a business application selected from the group consisting of billing, Enterprise Resource Planning (ERP), Customer Requirements Management (CRM), Supply Chain Management (SCM), Human Resource management.

31. The method of claim 30, wherein said business application is described in a formal language, selected from the group consisting of UML (unified modeling language) activity diagrams, UML sequence diagrams or UML state charts, BPEL (business process execution language) standard language, BPML (business process modeling language) standard language, or any other equivalent language.

32. A method for testing software for performing a business process, comprising:
analyzing the business process according to a plurality of general requirements and rules for the business process;
analyzing a specific implementation of the business process as software;
generating at least one abstract test for examining a behavior of the software as said specific implementation of the business process.

33. The method of claim 32, further comprising:
generating at least one detailed test description according to a plurality of constraints, said constraints being determined according to operating parameters of the software; and
generating at least one script according to said at least one detailed test description.

34. The method of claim 33, further comprising:
executing said at least one script;
analyzing results of said executing to assess performance of the software.

35. The method of claim 32, wherein said analyzing said specific implementation of the business process comprises determining a software specification for specifying a plurality of functions for the software.

36. The method of claim 35, further comprising:
assessing conformance of the software according to said software specification.

37. The method of claim 32, wherein said analyzing the business process further comprises:
determining a business process description.

38. The method of claim 37, wherein said business process description is provided in a formal language.

39. The method of claim 38, wherein said formal language is selected from the group consisting of UML (unified modeling language) activity diagrams, UML sequence diagrams, UML state charts, BPEL (business process execution language) standard language, or BPML (business process modeling language) standard language.

40. The method of claim 38, wherein analyzing the business process further comprises parsing said business process description.

41. The method of claim 37, wherein said analyzing the business process further comprises:
analyzing each transition of the business process.

42. The method of claim 41, wherein said transition comprises a starting state, a target state, and a condition or event that causes a change from said starting state to said target state.

43. The method of claim 41, wherein at least one test primitive for at least partially determining at least one abstract test is determined from at least one transition.

44. The method of claim 43, wherein a plurality of test primitives is determined for constructing a tree for determining said at least one abstract test.

45. The method of claim 43, wherein said at least one detailed test description is at least partially determined from at least one input and at least one event for said at least one transition.

46. The method of claim 44, wherein a plurality of tests are generated from said at least one detailed test description according to a directed random generator.

47. The method of claim 46, further comprising:
determining at least potential functional coverage of said plurality of tests by comparison to a set of all possible tests.

48. The method of claim 32, further comprising:
translating said plurality of tests into concrete calls to the tested software by using a connector hub technology.

49. The method of claim 48, further comprising:
generating a plurality of inputs according to the business process description; and
executing said plurality of tests.

50. The method of claim 49, further comprising:
analyzing results from said executing said plurality of tests for comparing with a plurality of expected results, said expected results being determined according to said business process description.

51. The method of claim 32, wherein the business process comprises a process selected from group consisting of billing, marketing and distribution, and personnel management.

52. The method of claim 32, wherein said analyzing said specific implementation of the business process comprises generating a finite state machine description of said plurality of general requirements and rules.
